(19) United States
(12) Patent Application Publication
(10) Pub. No.: US 2005/0010310 A1
(43) Pub. Date: Jan. 13, 2005

(54) Method of alignment for precision tools.

(76) Inventor: Igor Victorovich Touzov, Cary, NC (US)

Correspondence Address: IGOR V TOUZOV, 311 CASTLE HAYNE DRIVE, CARY, NC, 27519, US

(21) Appl. No.: 10/710,435

(22) Filed: Jul. 11, 2004

Related U.S. Application Data
(60) Provisional application No. 60/481,082, filed on Jul. 11, 2003.

(51) Int. Cl. G05B 19/18

(52) U.S. Cl. 700/56; 700/77

(57) ABSTRACT

The invention discloses methods and algorithms that enable precise refinement of current position of active regions of a complex tools with respect to a tool holder, which utilizes simple proximity data and dramatically improve precision of an instrument operations, where in wide range of applications includes nanotechnology, micromechanics, precision manufacturing, etc.

### CROSS REFERENCE To RELATED APPLICATIONS

This application is a regular application of provisional Patent Application No. 60/481,082, filed Jul. 11, 2003 which is hereby incorporated by reference in its entirety for all purposes.

### BACKGROUND OF INVENTION

A subject of the current invention closely relates to methods of precise alignment, which are necessary in processes of manufacturing, control and measurements at micro- and nano-scale technologies. In more particular case it relates to methods of establishing precise position of micro-/nano-scale tool with respect to the tool holding assembly. This task is essentially important for processes that require micro-/nano-meter resolution and imply in-process tool replacements or use multiple tools to perform sequential and/or parallel operations on the same physical substance. Examples of such processes are micromachining techniques, scanning tunneling lithography, scanning probe lithography, microcontact print based lithography. Current state of the art for this subject relies on use of plurality of additional components and sensors to perform alignment tasks. Methods employ optical interference: Stanton U.S. Pat. No. 6,469,793, Makosch U.S. Pat. No. 4,577,968, Uchida et al. U.S. Pat. No. 4,848,911, Ishibashi et al. U.S. Pat. No. 5,151,754, Komatsu et al. U.S. Pat. No. 5,171,999, Tian et al. U.S. Pat. No. 5,402,230, Gallatin et al. U.S. Pat. No. 5,559,601; patterned electromagnetic sensors: Leedy U.S. Pat. No. 6,294,909; scanning by laser beams: Suzuki U.S. Pat. No. 5,048,968; optical alignment techniques: Nishi U.S. Pat. No. 4,829,193; diffraction method: Trutna, Jr. U.S. Pat. No. 4,631,416; pattern imaging: Eby, Raymond K. et al. US 20030185967.

Optical interference methods of alignment provide efficient ways for alignment of macroscopic objects with fixed geometry at costs exponentially increasing with accuracy requirements. Patterned electromagnetic sensors have limitation to alignment accuracy of the same dimensional scale as a pattern period. Methods of laser scanning and optical alignment are limited in resolution to significant fraction of employed wavelength, which makes them inherently impractical for use at nanometer-scale. While method of pattern imaging does not have theses disadvantages it requires imaging of substrate and recognition of prerecorded pattern. This makes the implementation of said approach more difficult that the other techniques.

The method of the present invention avoids aforementioned disadvantages and relies of simple mathematical algorithms that neatly convert readings of single unidirectional proximity sensor into alignment data.

### SUMMARY OF INVENTION

Plurality of tools used for processing of bulk or surface structures of parts and materials. These tools are usually mounted in specialized holding device that maintains the tool position during its operation. Determination of precise position of the tool or its active region has principal effect on precision of work performed with the tool. This invention discloses a new method that allows calculation of precise position of the tool's active region (such as cutting edge(s), point(s), nozzle(s), focal point(s), etc.) using small angular adjustments of the holding device position. In comparison with existing methods this approach allows determination of current position of active region of the tool without use of any additional measurement instruments. The invention only requires single proximity sensor and flat calibration surface. In most cases surfaces of parts and materials that will be used for processing by the tool can be used as such calibration surfaces. The method has no dimensional restrictions and can be used to provide up to angstrom scale alignment accuracy.

### BRIEF DESCRIPTION OF DRAWINGS

FIG. 1 shows schematic diagram of an apparatus.

FIG. 2 shows basic calculations for computing relative tool position.

FIG. 3 shows use of the algorithm in case of three degrees of freedom.

FIG. 4 shows schema of an apparatus that contains additional tool positioning actuator.

FIG. 5 shows formulas for calculation of distances between the tool and appropriate actuators contact points of the tool holder.

### DETAILED DESCRIPTION

The subject of the invention describes an algorithm or method for determination of precise position of a tool mounted on a tool holder that is capable of performing measurable moves with two or more degrees of freedom and has as least one proximity sensor which readings can be used to characterize interaction between the tool and surface of a body. These proximity sensor can be an add-on feature of the toll or the tool itself. Examples of such integrations are scanning tunneling (beam) lithography and scanning probe lithography, where tool proximity data are available directly from the tool feedback channel.

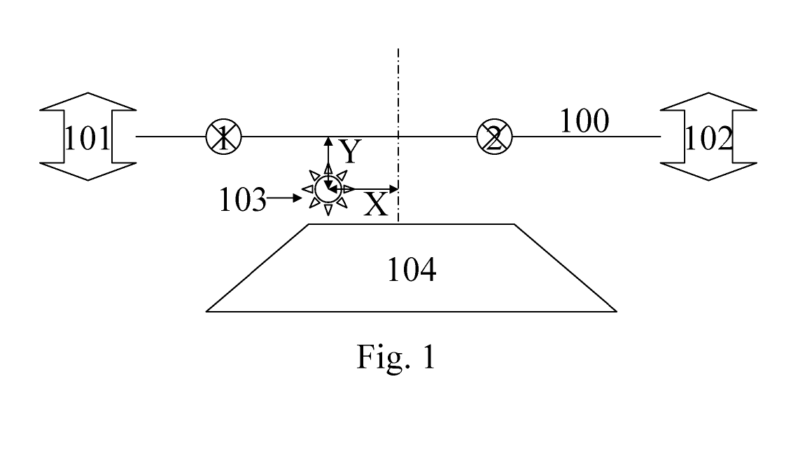

The first embodiment describes the invented algorithm reduced to the case of two dimensions/degrees of freedom. It does not intend to limit the use of the algorithm since it is obvious that the same procedure can be applied to cases of larger number of dimensions/degrees of freedom. FIG. 1 shows schematic diagram of an apparatus containing tool 103, tool holder 100, two one-dimensional actuators 101 and 102, and reference body surface 104. In real apparatus the role of the reference body 104 can be assigned to a calibration standard, subject of processing, etc. Following are the steps for algorithm execution:

1) tool 103 moves toward body 104 to be positioned within sensory range of the proximity sensor, where sensor responds to proximity, pressure, force, electric field, or any other factors in some extent dependent from relative position of the tool 103 and the reference body 104, and where the position changes may be occurring due to deformation of the tool 103 and or the body 104 or separation between them;

2) actuators 101 and 102 change the position of the holder 100 in the way that when the change is completed the sensor provides readings within its operational range and relative distances of each actuator travel are known, and the virtual rotation axis 1 can be computed;

3) optionally step 3 can be repeated several times using different travel distances for actuators and causing virtual rotation axis 2 to be distinct from axes in previous steps.

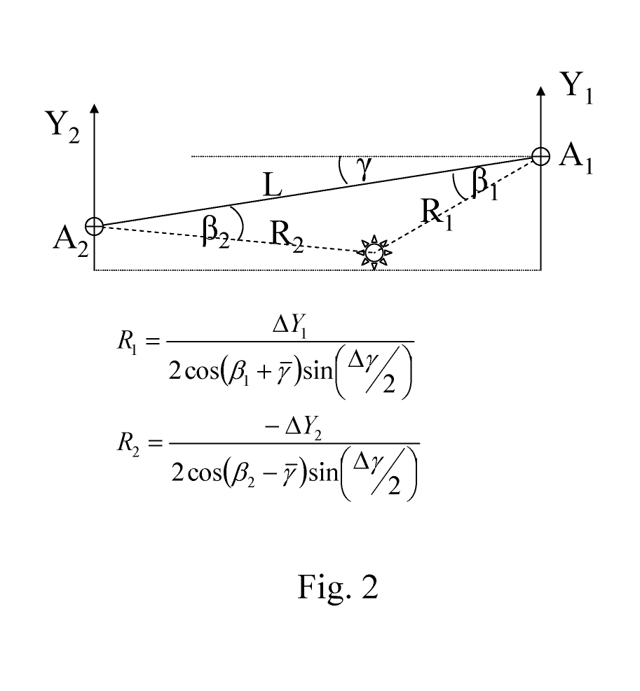

Completion of described steps provides sufficient data for computation of the tool 103 position with respect to the holder 100. FIG. 2 shows basic calculations for that. Values R₁ and R₂ identify distances between points of the holder actuators A and A and the tool and when computed will uniquely define its position. Values β₁ and β₂ indicate estimate view angle of the tool mount position. These values are obtained from geometry of the holder and does not necessarily precisely identify but rather approximate the tool location. Tilt value of the holder may be measured or computed based on the holder length L or distance between actuators A₁ and A₂ and their displacements Y₁ and Y₂. Each value Y₁ and Y₂ is relative position of corresponding actuator, only changes of these values are important for computation of the tool precise position. Formulas for computation of the tool position have high use measurements of changes in the positions of the actuators mounts Y₁ and Y₂ which also gives values for changes of tilt angles γ. This in fact is the primary benefit of the disclosed algorithm since in real-world execution of this algorithm only the changes in the values need to be measured and such measurements usually can be provided with high precision and ease.

Formulas shown on FIG. 2 use increment and average of computed values of tilt angles γ. It is obvious to anyone experience in the art that multiple measurements can be performed and their results can be accumulated to perform statistical evaluation of computed result and its accuracy.

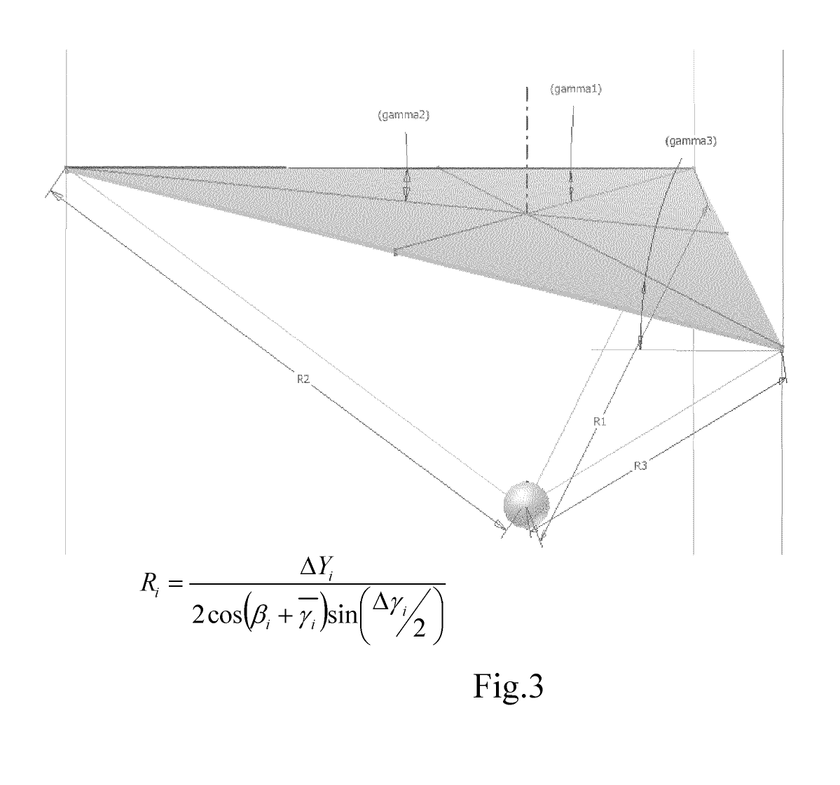

The algorithm disclosed in the previous paragraph gives exact position of the tool in case of two dimensions/degrees of freedom, by providing two distances R₁ and R₂ which allows triangulation of its position. In case of three dimensions/degrees of freedom the same algorithm can be used as illustrated on FIG. 3. Each value Rᵢ is computed using estimate values of βᵢ, measured change of actuators displacements Yᵢ and computed values of tilt angles γᵢ changes.

It is obvious that in all algorithms disclosed in this invention measurements of actuators positions changes can be substituted with measurements of appropriate tilt angles. In this case actuators positions changes can be easily computed.

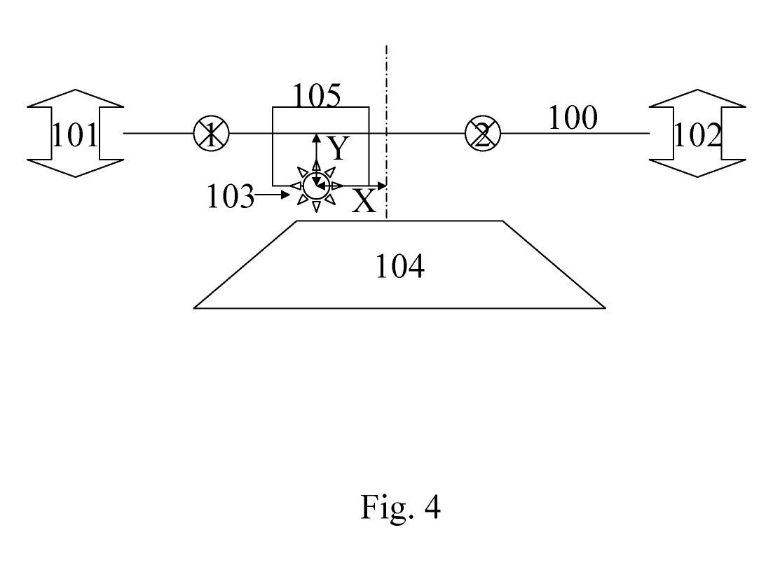

The second embodiment of the present invention discloses a method of performing detection of the tool position in design when tool holder contains additional actuators which are capable of positioning the tool with respect to the tool holder. FIG. 4 shows schema of an apparatus that contains additional tool positioning actuator 105. Method for performing this operation uses the following steps:

1) tool 103 moves toward body 104 to be positioned within sensor range, where sensor responds to proximity, pressure, force, electric field, or any other factors in some extent dependent from relative position of the tool 103 and the reference body 104, and where the position changes may be occurring due to deformation of the tool 103 and or the body 104 or separation between them, and positioning state (all displacements) of the actuator 105 is well known;

2) actuators 101 and 102 change the position of the holder 100 in the way that actuator 105 is capable to position the tool in such a way that when the change is completed the sensor provides readings within its operational range, and the relative distances of each actuator travel are known, and the virtual rotation axis 1 can be computed;

3) optionally step 3 can be repeated several times using different travel distances for actuators and may allow virtual rotation axis 2 to be distinct from axes in the previous steps.

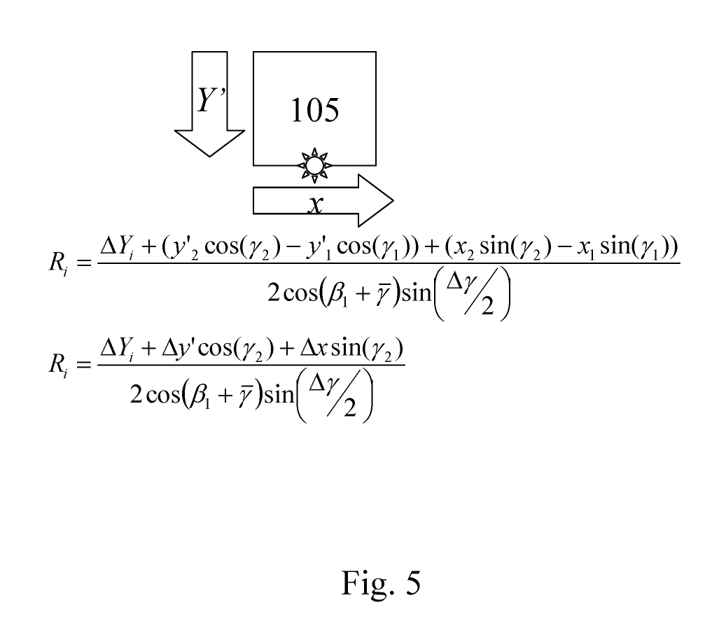

The invention includes an algorithm for computation of the tool's relative position with respect to the tool holder for at least one predefined state of actuator 105. FIG. 5 shows formulas for calculation of distances between the tool and appropriate actuators contact points of the tool holder. It is shown that tool actuator 105 produces motions in XY′ plane coplanar with plane of holder actuators motions (case of two dimensions). It is obvious that in general case these two coordinate systems can be different and any motion of actuator 105 can be presented as sequence of elementary motions in each coordinate system by means of linear transformation of their coordinates into desired coordinate space. This algorithm can provide higher precision than the algorithm described in the first embodiment in cases when positioning precision of actuator 105 is higher than the one of 101 and 102.

It is obvious that the method and the algorithm of the current embodiment can be applied to a tool holder apparatus that has only single holder positioning actuator and single actuator for positioning the tool with respect to the holder, as well as it is obvious that disclosed method equally applicable to designs where actuator 105 provides 0 through 6 degrees of freedom, and the tool holder 100 has 0 through 6 degrees of freedom, and the only requirement is that combined number of degrees of freedom is greater than 1.

It is also obvious that same method can be employed for the same purpose in designs where the tool or sensor remains immobile, but the body surface 104 posses degrees of freedom with respect to the holder 100 and can perform controlled motions.

The methods of previous embodiments can be used to detect position of multiple tools or sensors or a complex tool with multiple active sites. Tolls or sensors can be arranged in predetermined pattern or array. In order for disclosed methods to be used in these design scenarios inclination/tilt angles of the holder has to be selected in a way that only known tools/sensors are engaged into the method measurements. In case of multiple sensors this selection is achieved by ensuring that sensors employed in current measurements provide signals in operational range.

In case of complex tool that has multiple active region and number of sensors is less than the number of active regions, it is important to employ design data of the tool geometry to resolve ambiguity between current tilt angle and sensors reading and active tool region.

Examples of these designs include arrays of tunneling probes, arrays of passive or active micro cantilevers, near-field optical arrays, etc. all these arrays can be considered as a plurality of tools/sensors or as a single complex tool with multiple active regions and sensors. The methods of the present invention can be equally applied to all this cases to sequentially or simultaneously resolve locations of the tools/sensors. Sequential resolution implies measurements performed with multiple tilt angles that engage different active regions or sensors. Simultaneous resolution implies detection of multiple sensors data for each inclination/tilt angle. In more generic case combination of both approaches is used.

### EXAMPLES

Tool holder has linear size of 0.1 meter and two actuators movable by step motors with precision of 2.5 micrometers. Default location of the tool estimated to be below the holder by 1 millimeter and is approximately at its center. As initial step the tool is approached the calibration surface with holder tilt of 0 degrees. In second step right actuator retracts the holder from the surface by 2500 micrometers and left actuator approaches the surface until original sensor readings has been achieved. Its displacement is −2.5 micrometers below prior position. Using this data the tilt change computed to be ˜3 degree, and approximate view angles are 1 degree, vertical offset of the tool from its estimated position is 600 nanometers and horizontal offset is 25 micrometers.

In this example the parameters of the tool holder are the same as in the previous example. But actuator 105 is used ant it is capable of Y positioning with precision of 0.1 nanometer, and SPM cantilever type probe used as a tool and the sensor. Freshly cleaved crystal of HOPG is used as a calibration surface that assumes atomic flatness of the surface. The resulting precision of detection of the tool's vertical offset is 0.025 nm and its horizontal offset precision is 1 nm.

1. A method of detection of exact relative position of a tool or a sensor with respect to a holding element that involves:
proximity measurement with at least two different inclinations of the holding element with respect to a planar body's surface, and wherein the proximity measurements results reflect relative position of the tool/sensor with respect to said planar surface.

2. An algorithm described in this document that allows to compute precise position of a tool/sensor with respect to a holder which uses measurements or results obtained through the method of claim 1.

3. A method of claim 1 that utilizes a holder with multiple types of actuators or positioning motors, where in some actuators or motors provide coarse positioning of the holder or the tool with respect to the holder and other are capable of achieving higher precision positioning of the holder or of the tool/sensor with respect to the holder.

4. An algorithm described in this document that allows to compute precise position of a tool/sensor with respect to a holder for at least one predefined position of actuators capable of adjusting position of the tool with respect to the tool holder which uses measurements or results obtained through the method of claim 3.

5. A method of claim 1 where in the apparatus contains more than one sensor that responds to proximity, pressure, force, electric field, or any other factors in some extent dependent from relative position of the tool, and these sensors may be arranged in ordered pattern.

6. A method of claim 3 where in the apparatus contains more than one sensor that responds to proximity, pressure, force, electric field, or any other factors in some extent dependent from relative position of the tool, and these sensors may be arranged in ordered pattern.

7. An algorithm of claim 2 that uses data of multiple measurements and computes positions of different regions of a tool or multiple tools/sensors.

8. An algorithm of claim 4 that uses data of multiple measurements and computes positions of different regions of a tool or multiple tools/sensors.

9. An algorithm of claims 2 that uses data of multiple sensors and computes positions of different regions of tool.

10. An algorithm of claims 4 that uses data of multiple sensors and computes positions of different regions of tool.
